(19) United States
(12) Patent Application Publication
(10) Pub. No.: US 2003/0084757 A1
(43) Pub. Date: May 8, 2003

(54) WRENCH STRUCTURE WITH A MULTIPLE THREAD WORM

(76) Inventor: Jin-Fu Chen, Ta-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/985,703

(22) Filed: Nov. 6, 2001

(51) Int. Cl. B25B 13/16

(52) U.S. Cl. 81/165

(57) ABSTRACT

A wrench structure including a main body having a handle extending therefrom. A fixed jaw projects from one end of the main body opposite to the handle. A movable jaw is disposed at the end of the main body and slidable relative to the fixed jaw. The main body is formed with a receiving hole. A worm is disposed in the receiving hole and engaged with a rack of the movable jaw. The worm is a multiple-thread worm having multiple parallel spirals spaced from each other. The multiple-thread worm has an elongated pitch, whereby when turning the worm, the movable jaw can be quickly moved to adjust the position thereof.

### BACKGROUND OF THE INVENTION

The present invention is related to an improved wrench structure in which the position of the movable jaw can be quickly adjusted to clamp or loosen a work piece.

FIGS. 9 and 10 show an existent adjustable wrench including a main body 8 having a handle 81. One end of the main body 8 opposite to the handle 81 has a fixed jaw 82 and is formed with an adjustment hole 83 passing through the main body 8. A worm 84 is disposed in the adjustment hole 83. A spring 841 is disposed between the top of the worm 84 and the wall of the adjustment hole 83 to keep the worm 2 located. An outer side of the adjustment hole 83 is formed with a slide channel 87 passing through the main body 8. A rack 86 of a movable jaw 85 is inlaid in the slide channel 87 and engaged with the worm 84.

It is hard to increase the length of the worm 84. In order to increase the number of the teeth of the worm 84 meshing with the rack 86 to achieve larger frictional face, the worm 84 is generally designed as single-thread worm which is easy to process and has shorter pitch as shown in FIG. 11. Accordingly, the number of the teeth of the engaged worm 84 and rack 86 is increased so as to provide sufficient supporting force for the movable jaw 85. However, the shorter pitch p of the worm 84 makes it time-consuming to turn the worm 84 for adjusting the position of the movable jaw 85. Therefore, the movable jaw 85 can be hardly quickly adjusted to tightly clamp or loosen a work piece.

In order to quickly adjust the movable jaw 85 to clamp or loosen the work piece, the pitch of the worm 84 can be enlarged into p1 as shown in FIG. 12. However, under such circumstance, the number of the teeth of the engaged worm 84 and rack 86 is reduced so that the worm 84 will be unable to provide sufficient supporting force for the movable jaw 85.

FIGS. 13 and 14 show another existent adjustable wrench 9 which can be quickly adjusted. The bottom end of the worm 91 is formed with a toothed section 911. In addition, two pulleys 94, 95 drivingly engaged with a toothed belt 93 are disposed in the handle 92. The pulley 94 is connected with a gear 96 engaged with the toothed section 911 of the worm 91. By means of pushing a push button 931 connected with the toothed belt 93, the toothed belt 93 is moved to make the gear 96 drive and quickly rotate the worm 91. Therefore, the position of the movable jaw 97 can be quickly adjusted to tightly clamp or loosen the work piece between the movable jaw 97 and the fixed jaw 98.

The worm of the above adjustable wrench can be quickly rotated to adjust the position of the movable jaw. However, many additional components are necessary so that the structure of such wrench is quite complicated and it is difficult to manufacture such wrench and the manufacturing cost is increased. Some other adjustable wrenches include additional ratchet mechanisms or shifting mechanisms in cooperation with the worm for quickly clamping or loosening the work piece. All these wrenches include additional components and have complicated structures and are manufactured at high cost.

FIGS. 15 and 16 show an adjustable wrench disclosed in U.S. Pat. No. 953,346. The spiral 711 of the worm 71 of the adjustable wrench 7 is interrupted so that the worm 71 is formed with two axially extending interrupting channels 712 free from the spiral. The width of the interrupting channel 712 is slightly larger than the width of the rack 721 of the movable jaw 72. After the worm 71 is rotated to aim the interrupting channel 712 at the rack 721, the movable jaw 72 can be quickly moved.

However, it is necessary to additionally process the worm 71 to form the interrupting channels 712 on the spiral 711. This makes it more difficult to manufacture the worm 71 and leads to increased cost. Furthermore, the strength of the spiral 711 of the worm 71 will be weakened and the supporting force for the movable jaw 72 will be reduced. In addition, the interrupting channels 712 cannot mesh with the rack 721 of the movable jaw 72 so that it is uneasy to adjust the position of the movable jaw 72.

Summarily, all the above conventional measures for quickly adjusting the position of the movable jaw to clamp or loosen a work piece are hard to manufacture and are manufactured at high cost. With respect to the wrench in which the worm is formed with interrupting channels, it is uneasy to perform the adjustment. Therefore, it is necessary to develop an adjustable wrench which has simple structure and can be easily manufactured and quickly adjusted to clamp or loosen a work piece.

### SUMMARY OF THE INVENTION

It is therefore a primary object of the present invention to provide an improved wrench structure in which the worm is a multiple-thread worm having elongate pitch. In addition, there are still many teeth of the worm engaged with the rack of the movable jaw to achieve larger frictional area and enhance the resistance against the reaction force. The tooth thickness of the worm is increased so as to reinforce the worm. Therefore, without adding any component into the wrench, the position of the movable jaw can be quickly adjusted to clamp or loosen a work piece.

It is a further object of the present invention to provide the above wrench structure in which without adding any component into the wrench, the worm is directly made as a multiple-thread worm so that it is easier to manufacture the wrench.

It is still a further object of the present invention to provide the above wrench structure in which the main body of the wrench is formed with a receiving hole in which the worm is disposed. The handle of the wrench is formed with a flute extending to the receiving hole, whereby the turning angle of the worm can be enlarged so as to speed the adjustment of the position of the movable jaw.

The present invention can be best understood through the following description and accompanying drawings wherein:

### BRIEF DESCRIPTION OF THE DRAWINGS

FIG. 1 is a perspective view of the wrench of the present invention;

FIG. 2 is a sectional view of a part of the wrench of the present invention;

FIG. 3 is a plane view of the worm of the wrench of the present invention;

FIG. 4 shows the relationship between the pitch and spiral angle of the worm of the present invention;

FIG. 5 shows that the worm of the present invention is turned in a using state;

FIG. 6 shows that the worm of a conventional wrench is turned in a using state;

FIG. 7 is a plane view of a triple-thread worm of the present invention;

FIG. 8 is a plane view of another type of triple-thread worm of the present invention;

FIG. 9 shows an existent adjustable wrench;

FIG. 10 is a sectional view of a part of the existent adjustable wrench of FIG. 9;

FIG. 11 is a plane view of the worm of the existent adjustable wrench of FIG. 9;

FIG. 12 is a plane view of a worm having longer pitch;

FIG. 13 shows an existent adjustable wrench which can be quickly adjusted;

FIG. 14 is a sectional view of the existent adjustable wrench of FIG. 13;

FIG. 15 shows another type of existent adjustable wrench;

FIG. 16 is a sectional view taken along line 16-16 of FIG. 15.

### DETAILED DESCRIPTION OF THE PREFERRED EMBODIMENTS

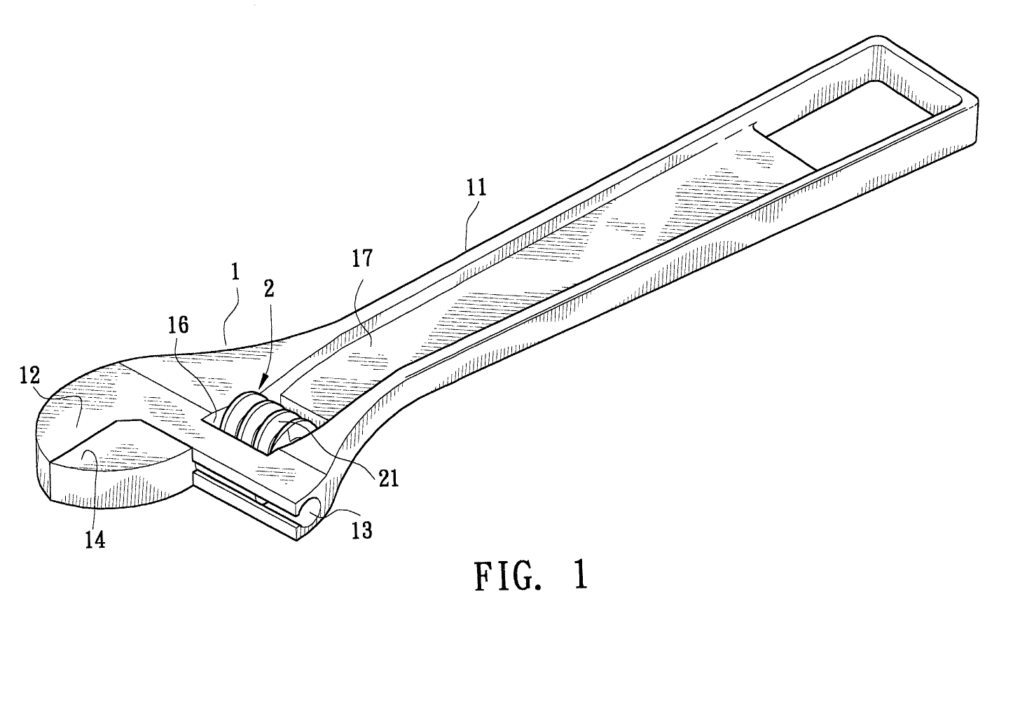

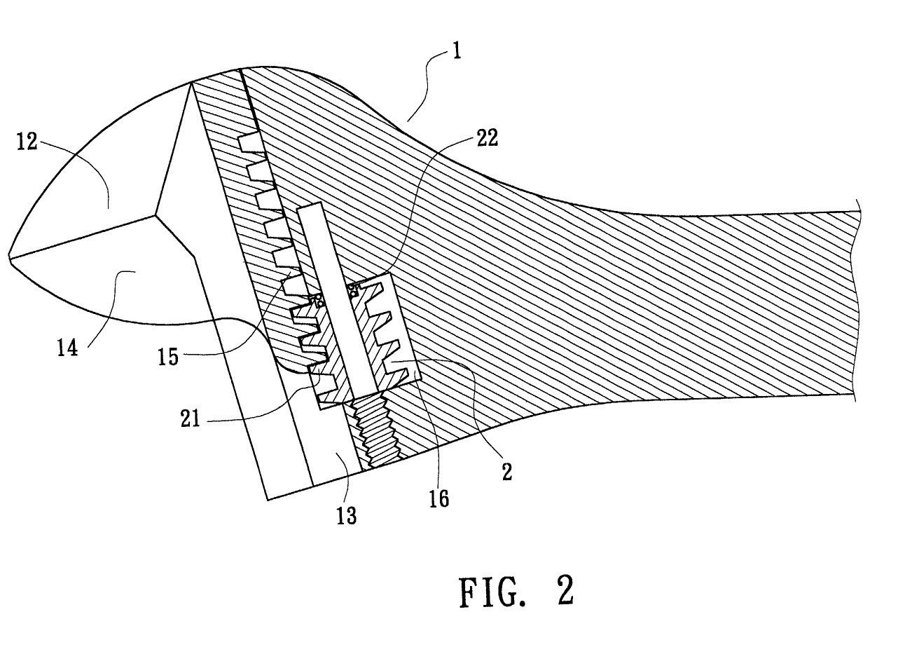

Please refer to FIGS. 1 to 4. The wrench structure of the present invention includes a main body 1 having an extending handle 11. A fixed jaw 12 projects from one end of the main body 1 opposite to the handle 11. The main body 1 is formed with a slide channel 13. A rack 15 of a movable jaw 14 is inlaid in the slide channel 13. The main body 1 is formed with a receiving hole 16 communicating with the slide channel 13 as shown in FIG. 2. The handle 11 has a substantially H-shaped cross-section, whereby the handle 11 has a flute 17 extending along the handle 11. The flute 17 has a width approximately equal to the length of the receiving hole 16. The flute 17 extends to the receiving hole 16. A worm 2 is disposed in the receiving hole 16 and engaged with the rack 15 of the movable jaw 14. The worm 2 is a multiple-thread worm. In this embodiment, the worm 2 is a double-thread worm having two parallel spirals spaced from each other. The pitch P of the worm 2 is twice the pitch of a general worm. A spring 22 is disposed between the top of the worm 2 and the top wall of the receiving hole 16 to keep the worm 2 in its home position.

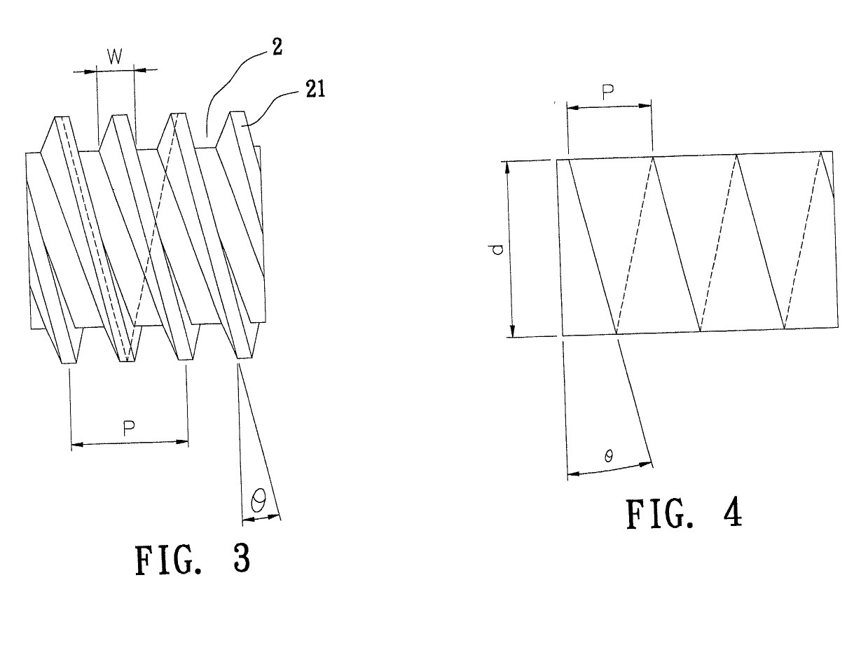

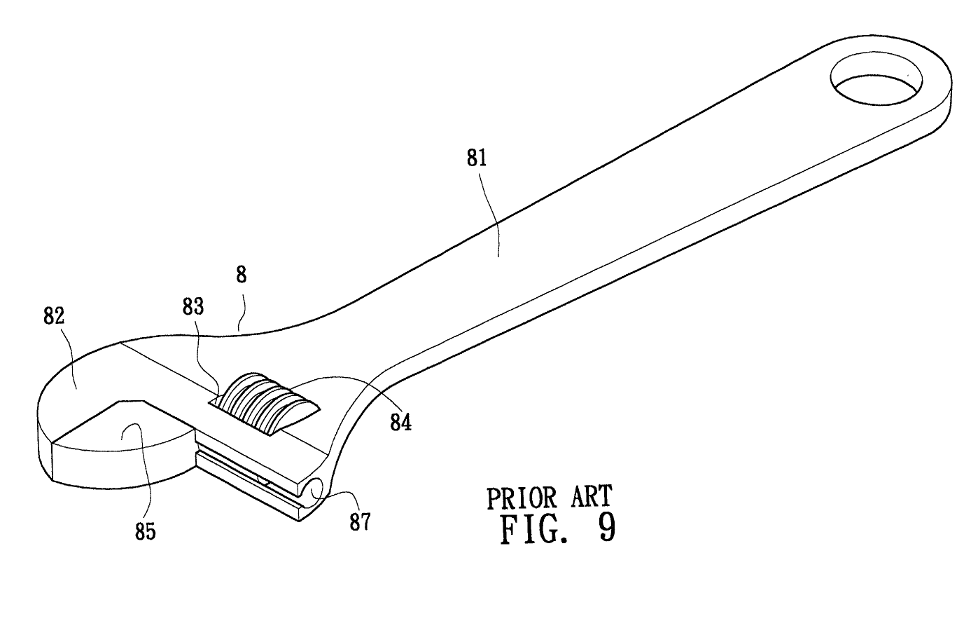

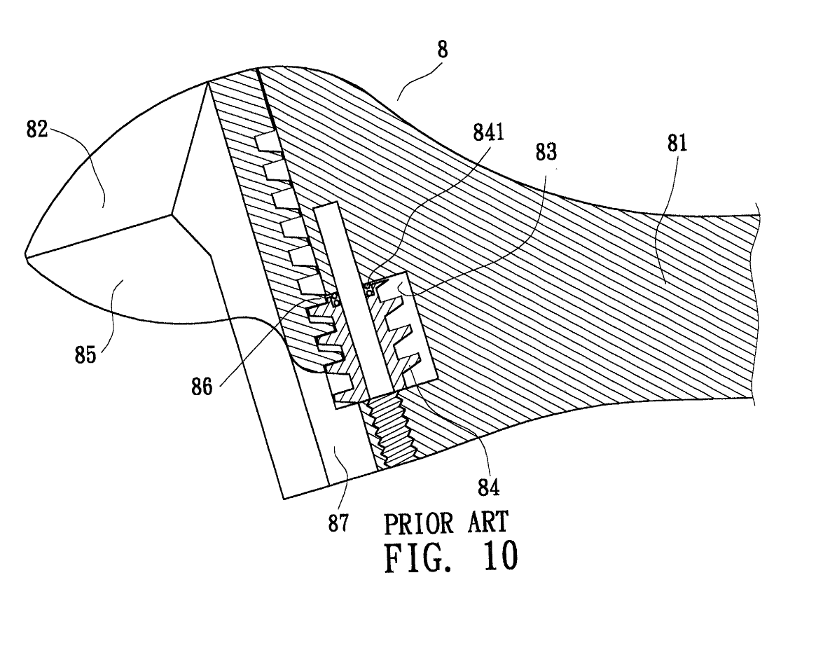

Referring to FIG. 3, the worm 2 is a double-thread worm having a pitch P twice the pitch of a general worm. Within the same length, more teeth 21 are provided for engaging with the rack 15. In comparison to the single-thread worm of FIG. 9, the worm 2 of the present invention has the equal number of teeth 21 for meshing with the rack 15. However, the pitch P of the worm 2 of the present invention is twice the pitch p of the single-thread worm of FIG. 9. In other words, travel of the movable jaw 15 of the present invention is twice that of the single-thread worm so that the position of the movable jaw 15 can be more quickly adjusted.

Referring to FIG. 4, the relationship between the pitch P and spiral angle of the worm 2 is as follows:

tan=P/d

Therefore, in the case of the same diameter, the enlarged pitch P leads to enlarged spiral angle. That is, the thickness W of the teeth of the double-thread worm 2 will be thicker than the thickness w of the teeth of the conventional single-thread worm. The thicker tooth thickness W enables the worm 2 engaged with the rack 15 to provide better supporting force for the movable jaw 14. Therefore, the wrench of the present invention can bear greater torque.

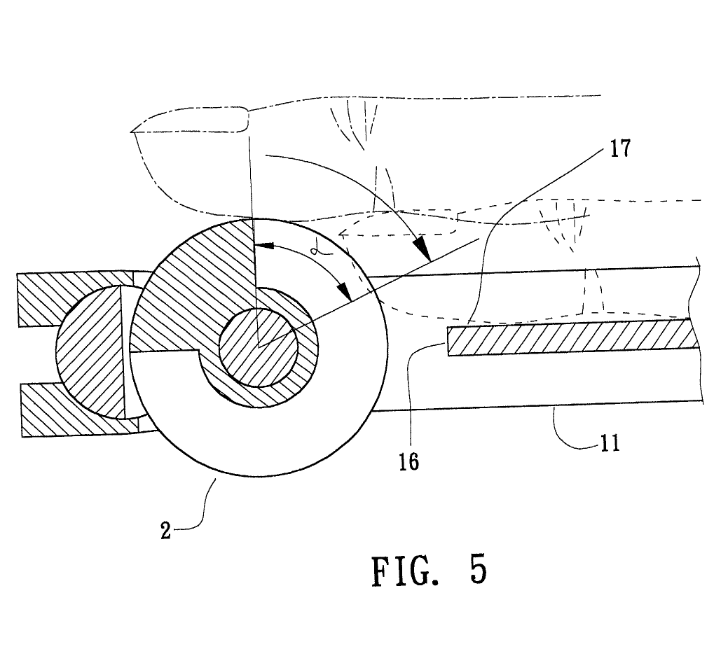

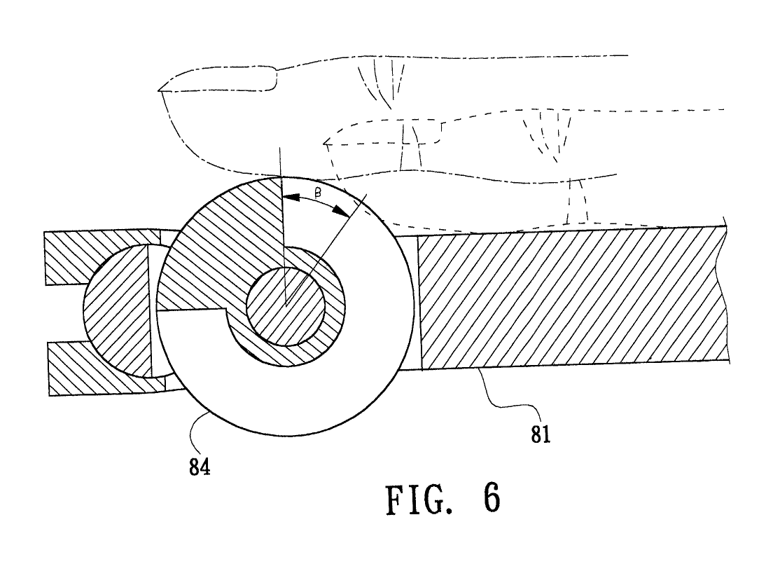

Referring to FIG. 5, when turning the worm 2, a user's finger can move into the flute 17 of the handle 11 to turn the worm 2 by an angle . Referring to FIG. 6 which shows a conventional wrench without any flute on the handle 81, when turning the worm 84, the user's finger can only move to abut against the handle 81. Therefore, the worm 84 can be only turned by an angle. Comparing FIG. 5 with FIG. 6, it is obvious that >. That is, by means of the flute 17 of the handle 11, the turning angle of the worm 2 is increased so that the adjustment of the movable jaw 14 is speeded.

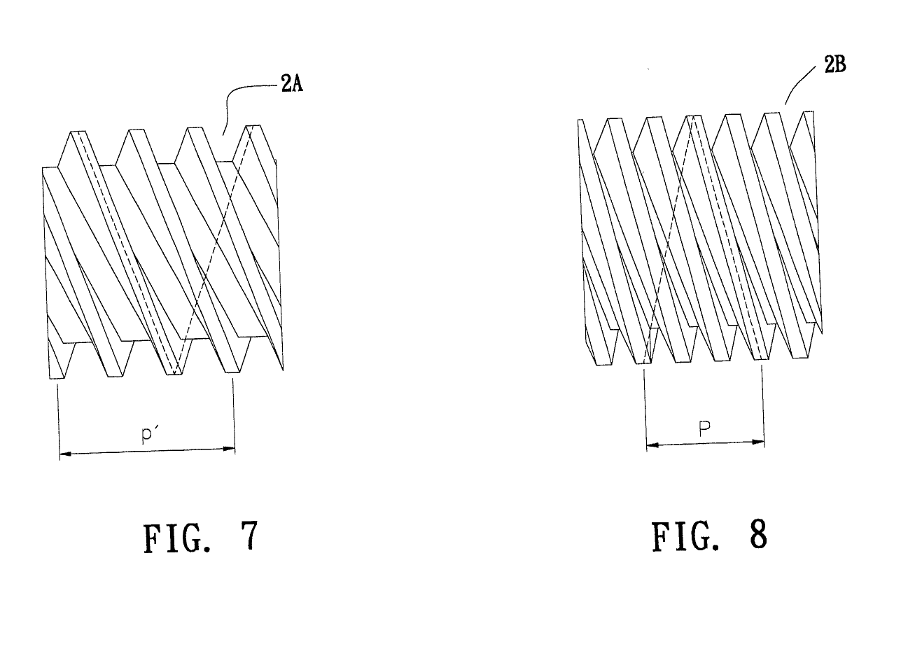

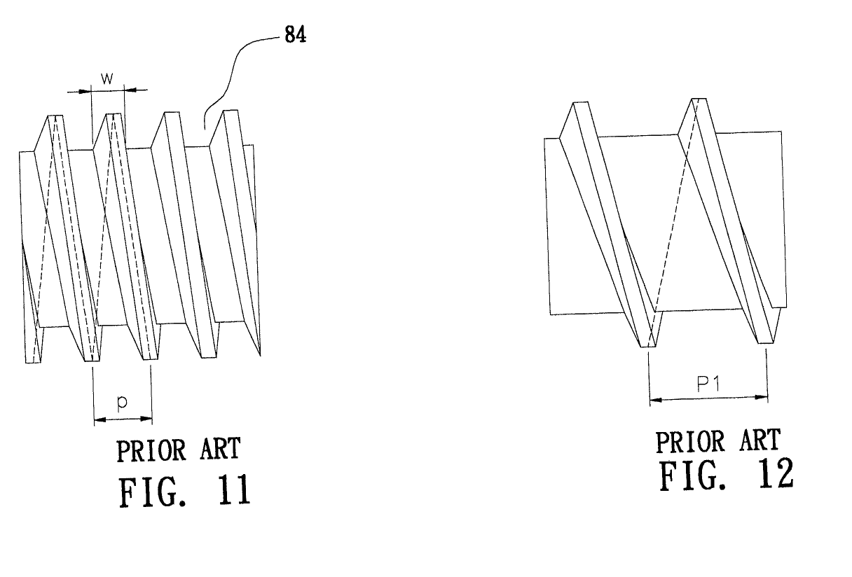

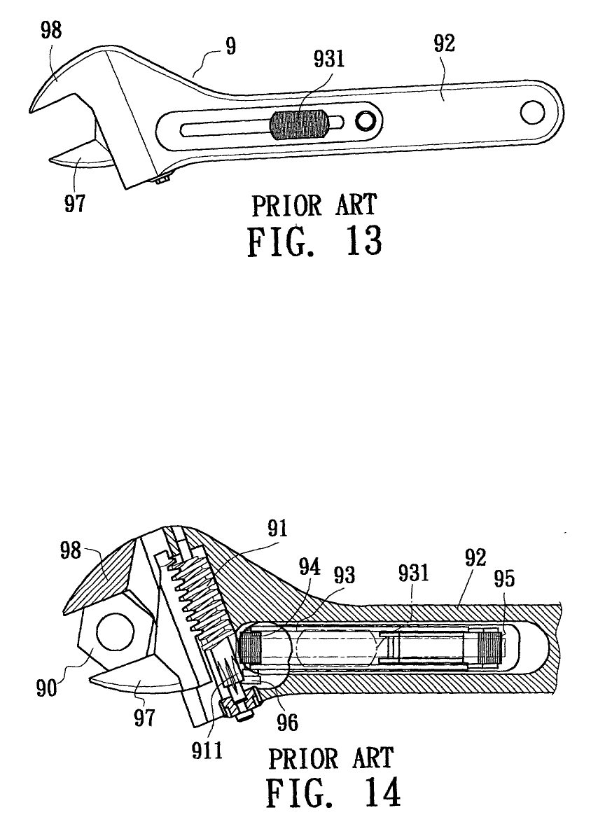

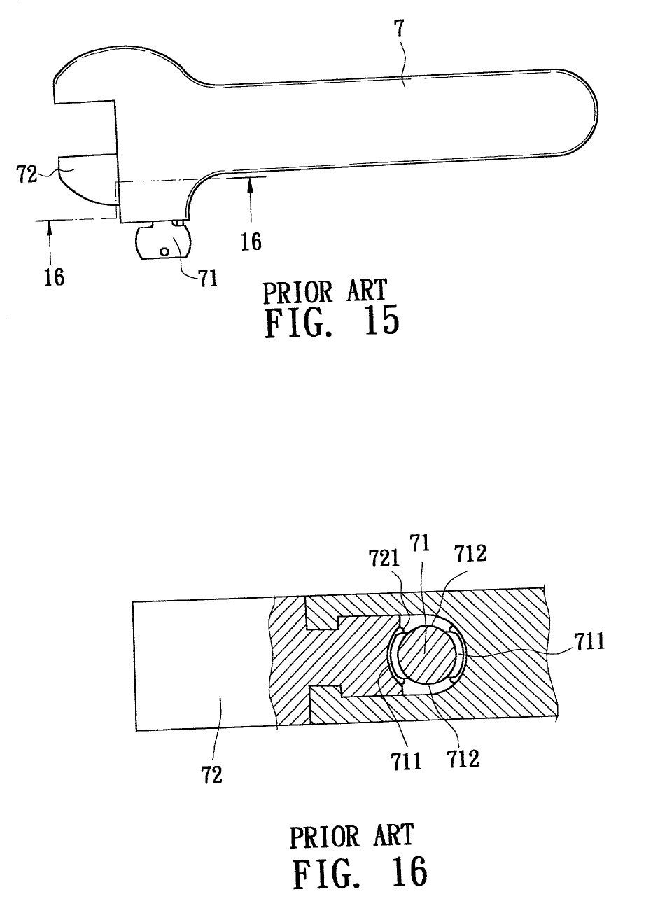

Alternatively, the worm of the present invention can be a triple-thread worm as shown in FIG. 7. The pitch P′ of the worm 2A is three times the pitch p of the single-thread worm of FIG. 9. Alternatively, the worm of the present invention can be a triple-thread worm as shown in FIG. 8. The pitch P of the worm 2B is equal to the pitch of the aforesaid double-thread worm, which is twice the pitch p of the single-thread worm of FIG. 11. Alternatively, the worm of the present invention can be any other multiple-thread worm.

Without adding any component into the wrench of the present invention, the multiple-thread worm of the present invention makes it easy to manufacture the wrench at low cost. Furthermore, the multiple-thread worm elongates the pitch P of the worm 2 so that the position of the movable jaw 14 can be quickly adjusted to clamp or loosen a work piece. In addition, there are still many teeth 21 of the worm 2 engaged with the rack 15 of the movable jaw 14 and the tooth thickness W of the worm 2 is increased so as to provide enhanced supporting force for the movable jaw 14.

The present invention has the following advantages:

1. Without adding any component into the wrench and only by means of the multiple-thread worm, the pitch P is increased so as to more quickly adjust the position of the movable jaw 14 for clamping or loosening a work piece.

2. There are still many teeth 21 of the worm 2 engaged with the rack 15 of the movable jaw 14.

3. The tooth thickness W of the worm 2 is increased so as to provide enhanced supporting force for the movable jaw 14.

The above embodiments are only used to illustrate the present invention, not intended to limit the scope thereof. Many modifications of the above embodiments can be made without departing from the spirit of the present invention.

What is claimed is:

1. A wrench structure comprising a main body having a handle extending therefrom, a fixed jaw projecting from one end of the main body opposite to the handle, the main body being formed with a slide channel, a rack of a movable jaw being inlaid in the slide channel, the main body being formed with a receiving hole communicating with the slide channel, a worm being disposed in the receiving hole and engaged with the rack of the movable jaw, the worm being a multiple-thread worm having multiple parallel spirals spaced from each other.

2. The wrench structure as claimed in claim 1, wherein the worm is a double-thread worm having a pitch twice the pitch of a single-thread worm.

3. The wrench structure as claimed in claim 1, wherein the worm is a triple-thread worm having a pitch three times the pitch of a single-thread worm.

4. The wrench structure as claimed in claim 1, wherein the worm is a triple-thread worm having a pitch twice the pitch of a single-thread worm.

5. The wrench structure as claimed in claim 1, wherein the handle has a substantially H-shaped cross-section, whereby the handle has a flute extending along the handle, the flute having a width approximately equal to the length of the receiving hole, the flute extending to the receiving hole.
